(19) United States
(12) Patent Application Publication
(10) Pub. No.: US 2013/0189475 A1
(43) Pub. Date: Jul. 25, 2013

(54) POLYSILOXANE SKINNED FLEECE

(71) Applicants: Bryan F. Cindrich, Tucson, AZ (US); David C. Rasmussen, Tucson, AZ (US); Bryce D. Notheis, Tucson, AZ (US)

(72) Inventors: Bryan F. Cindrich, Tucson, AZ (US); David C. Rasmussen, Tucson, AZ (US); Bryce D. Notheis, Tucson, AZ (US)

(73) Assignee: RAYTHEON COMPANY, Waltham, MA (US)

(21) Appl. No.: 13/354,132

(22) Filed: Jan. 19, 2012

(51) Int. Cl. D04H 11/00; B32B 38/16; B44C 1/165; B32B 27/12; B32B 27/02

(52) U.S. Cl. 428/96; 156/235; 156/64

(57) ABSTRACT

An article is provided and includes a fleece layer and layers of polysiloxane materials applied as a skin to both sides of the fleece layer.

### GOVERNMENT RIGHTS STATEMENT

The subject matter for this application was developed in part under government contract number FA8675-07-C-0055. The government has certain rights to this invention.

### BACKGROUND

The subject matter disclosed herein relates to a polysiloxane skinned fleece and, more particularly, to a silicone skinned fleece.

Environmental testing of products, such as those used in missile systems, require that base materials used in the construction of dynamic environment barriers have certain properties. For example, the base materials must be electro-static discharge (ESD) safe and non-debris generating. In addition, the base materials should provide for thermal and moisture barriers and should remain flexible from −60° C. to 100° C., or more.

Currently, commercially available materials are bendable but have inherent “in plane” stiffness (i.e., two dimensional flexibility). Also, many are debris or foreign object debris (FOB) generating, insufficiently tear resistant and have insufficient thermal resistance.

### SUMMARY

According to one aspect, an article is provided and includes a fleece layer and layers of polysiloxane materials applied as a skin to both sides of the fleece layer.

According to another aspect, a second order article is provided and includes a fleece layer, layers of polysiloxane materials applied as a skin to an interior side of the fleece layer and an exterior side of the fleece layer and a bond formed of polysiloxane materials formed at a seam of the fleece layer.

According to yet another aspect, a method of forming an article is provided and includes screeding a polysiloxane material in paste form onto a non-stick surface to have a predefined thickness, while the screeded polysiloxane material remains in paste form, marrying a first side of a fleece layer to the screeded polysiloxane material, curing the polysiloxane material to form an intermediate article and repeating the screeding and marrying operations with respect to a second side of the fleece material to form a skinned fleece.

These and other advantages and features will become more apparent from the following description taken in conjunction with the drawings.

### BRIEF DESCRIPTION OF THE DRAWINGS

The subject matter of the disclosure, is particularly pointed out and distinctly claimed in the claims at the conclusion of the specification. The foregoing and other features, and advantages of the invention are apparent from the following detailed description taken in conjunction with the accompanying drawings in which:

FIG. 1 is a side view of a polysiloxane skinned fleece;

FIG. 2 is a perspective view of a second order article;

FIG. 3 is a perspective view of a second order article, such as a thermal sock, in accordance with embodiments;

FIG. 4 is a perspective view of a component of the thermal sock of FIG. 3;

FIG. 5 is a perspective view of a tool for forming an article; and

FIG. 6 is a perspective view of additional components of the tool for forming the article.

The detailed description explains embodiments of the disclosure, together with advantages and features, by way of example with reference to the drawings.

### DETAILED DESCRIPTION

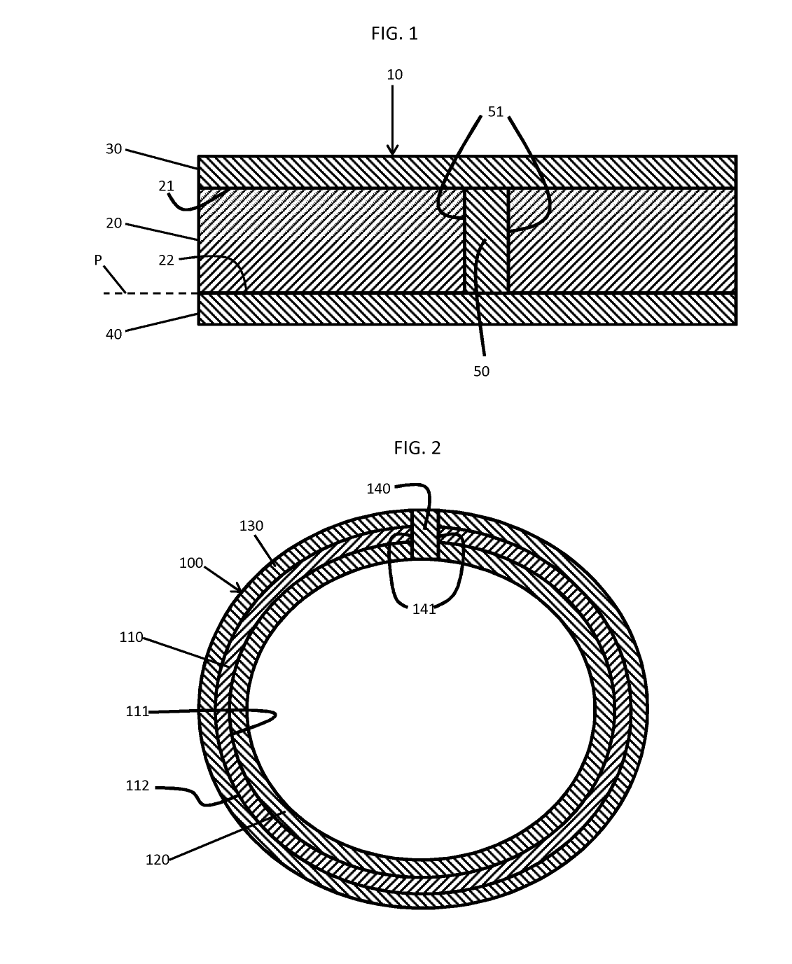

With reference to FIG. 1, an article 10 is provided. The article 10 includes a fleece layer 20 having a first side 21 and a second side 22, which opposes the first side 21. The article 10 further includes a first layer 30 of a polymerized siloxane (hereinafter referred to as “polysiloxane material”) applied as a skin to the first side 21 of the fleece layer 20 and a second layer 40 of a polysiloxane material applied as a skin to the second side 22 of the fleece layer 20. In accordance with embodiments, the fleece layer 20 may be formed of various materials including, but not limited to, polyester fleece. The polysiloxane materials of the first layer 30 and the second layer 40 may be similar or different and may include various materials including, but not limited to, silicone. In accordance with further embodiments, the first layer 30 and the second layer 40 may be formed of carbon loaded silicone. Additional additives, such as hydrogen, oxygen, boron and/or metallic materials, can of course be added to the silicone for providing further and/or alternative properties.

The first layer 30 and the second layer 40 may be bonded to the first and second sides 21 and 22 of the fleece layer 20 as a result of formation processes of the article 10 as a whole, which will be described in detail below, or by adhesive disposed between the layers. In any case, the article 10 may be formed with the first layer 30 and the second layer 40 having respective thicknesses of about for example 0.020 to 0.030 inches and with the fleece layer 20 being provided as one or more individual fleece layers that can be about for example ⅜ to ½ of an inch thick. In addition, as shown in FIG. 1, a bond 50 may be formed of polysiloxane materials at seam(s) 51 of the fleece layer 20.

With this construction, the article 10 provides for three-dimensional flexibility such that the article 10 is able to crumple like a fabric. That is, the article 10 can be bent in directions transverse to the plane, P, of the article 10 and in the plane, P. This property allows the article 10 to be used in the design of for example complex shaped environmental barriers even when space is limited. The article 10 is also electro-static discharge (ESD) safe, non-debris generating, tear resistant at least when compared with silicone sponge rubber and should provide for a thermal and moisture barrier. Also, the article 10 has a higher thermal resistance than silicone sponge rubber (roughly 1.7 times higher) and may thus be thinner than similar articles formed of silicone sponge rubber and/or other similar materials. In particular, the article 10 should remain flexible from −60° C. to 100° C., or more.

With reference to FIG. 2, a second order article 100 is provided and is formed by manipulation of the article 10 into a given shape, such as a cylinder, for example. The second order article 100 is thus formed of a similar layered construction as the article 10 and, for the exemplary cylindrical case, includes a fleece layer 110 having an interior facing side 111 and an exterior facing side 112 that is similar to fleece layer 20 of the article 10. The second order article 100 further includes a first layer 120 of polysiloxane materials applied as a skin to the interior facing side 111 of the fleece layer 110 and a second layer 130 of polysiloxane materials applied as a skin to the exterior facing side 112 of the fleece layer 110. A bond 140 is formed of polysiloxane materials at seam(s) 141 of the fleece layer 110.

As described above and, in accordance with embodiments, the fleece layer 110 may be formed of various materials including, but not limited to, polyester fleece. The polysiloxane materials of the first layer 120 and the second layer 130 may be similar or different and may include various materials including, but not limited to, silicone. In accordance with further embodiments, the first layer 120 and the second layer 130 may be formed of carbon loaded silicone with or without additional additives. The first layer 120 and the second layer 130 may be bonded to the interior facing side 111 and the exterior facing side 112 of the fleece layer 110 as a result of formation processes of the second order article 100 as a whole, which will be described in detail below, or by adhesive disposed between the layers. In any case, the second order article 10 may be formed with the first layer 120 and the second layer 130 having respective thickness of about for example 0.020-0.030 inches and the fleece layer 110 being provided as one or more individual fleece layers that can be about for example ⅜ to ½ of an inch thick.

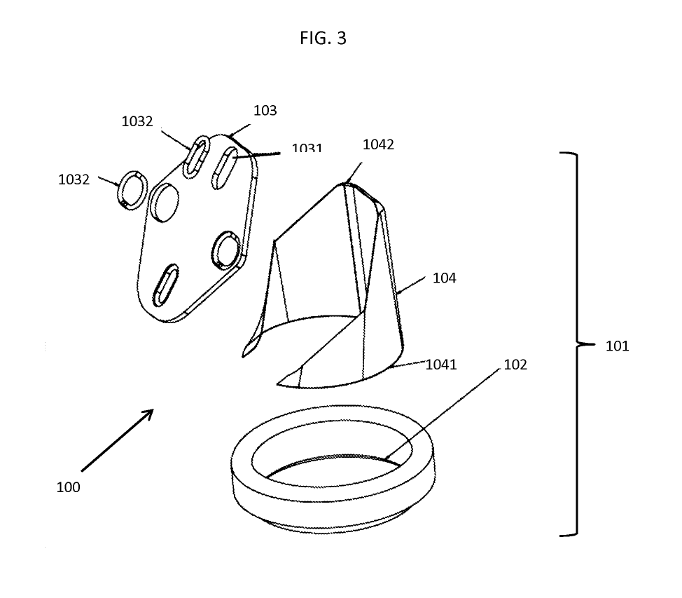

In accordance with an exemplary embodiment and, with reference to FIG. 3, the second order article 100 may be formed as a shaped thermal sock 101. In this case, as shown in FIG. 3, the fleece layer 110 and the first and second layers 120 and 130 cooperatively form a turtleneck portion 102, a head portion 103 and a cape portion 104. The turtleneck portion 102 is configured to be sealably coupled to a tool, such as an environmental testing device, and may include one or more o-ring seals that are bonded to the body of the turtleneck portion 102 at lower ends thereof. The head portion 103 defines sealed apertures 1031 having o-ring seals 1032 bonded thereto through which tool elements are extendable. The cape portion 104 is supportively interposed between the turtleneck portion 102 and the head portion 103. The bond 140 described above may be formed as a plurality of bonds 1041 and 1042 at respective interfaces between the cape portion 104 and the turtleneck portion 102 and the head portion 103.

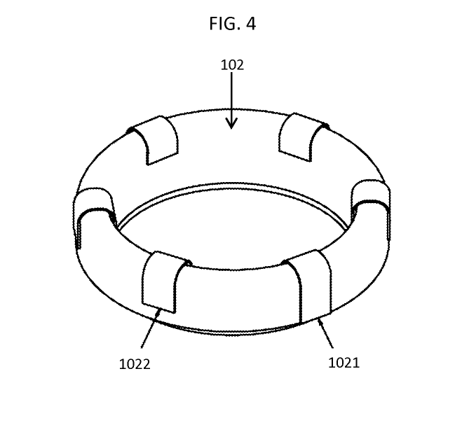

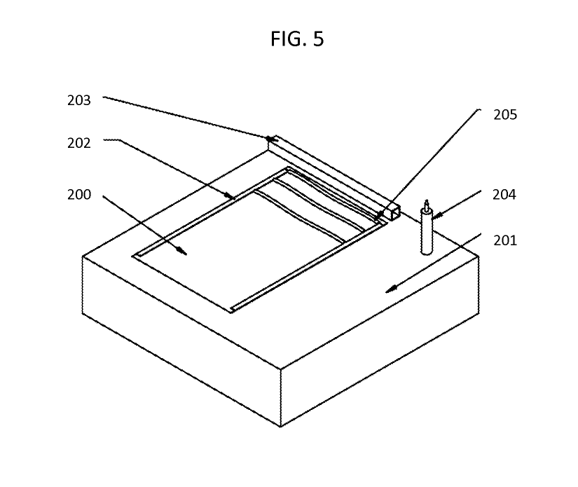

With reference to FIG. 4, the turtleneck portion 102 may include long doublers 1021 and short doublers 1022. Both the long and short doublers 1021 and 1022 are applied to the turtleneck portion by adhesive and may be formed of silicone sponge rubber and serve to cover or seal portions where the second order article 100 has been cut. These portions facilitate the formation of the second order article 100 into the turtleneck portion 102 by decreasing the likelihood of material puckering during the formation stage. Similar doublers can be applied to the head portion 103 and the cape portion 104.

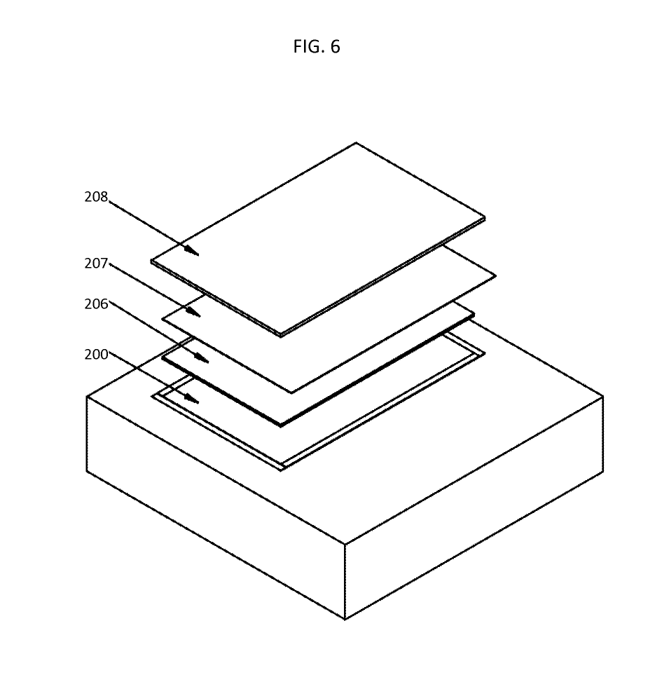

With reference to FIGS. 5 and 6, a method of forming the article 10 and the second order article 100 is provided. As shown in FIG. 5, the method initially includes screeding a polysiloxane material in paste form onto a non-stick surface 200 of a tool 201 to have a predefined thickness. The tool 201 has a main body and a substantially planar surface where the non-stick surface 200 is provided. In accordance with embodiments, the non-stick surface 200 may be formed of Teflon™ coated fabric and/or other similar materials. The tool 201 further includes spacers 202 disposed around the non-stick surface 200, a bar 203 that is slidably coupled to the tool 201 and a poly-siloxane material dispenser 204.

Polysiloxane material 205 is applied to the non-stick surface 200 via the dispenser 204 in paste form. The bar 203 is then slid across the non-stick surface 200 such that the polysiloxane material 205 is spread out substantially evenly. The spacers 202 maintain a separation between the non-stick surface 200 and the bar 203 that defines the thickness of the first layers 30, 120 described above. There are, of course, alternative processes available for applying the polysiloxane material 205 to the non-stick surface 200. For example, the applicant may be done manually or by pressing the polysiloxane material 205 onto the non-stick surface 200 with a complementary non-stick surface.

As shown in FIG. 6, while the screeded polysiloxane material 205 remains in paste form, a first side of a fleece layer 206 is married to the screeded polysiloxane material 205 in any one of various processes. These processes may include, but are not limited to, applying weight onto the fleece layer 206 by laying a first layer 207 and a weight 208 on the fleece layer 206. In accordance with embodiments, the first layer 207 may include a perforated aluminum layer. These processes continue as the polysiloxane material 205 is cured and thereby bonded with the fleece layer 206 to form an intermediate article. Once the curing is complete, the intermediate article is removed from the non-stick surface 200 and the processes described above are repeated with respect to the other side of the fleece layer 206 to form a skinned fleece or, more particularly, a polysiloxane (or silicone) skinned fleece.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An article, comprising:
a fleece layer; and
layers of polysiloxane materials applied as a skin to both sides of the fleece layer.

2. The article according to claim 1, wherein the fleece layer comprises a polyester fleece.

3. The article according to claim 1, wherein the polysiloxane materials comprise carbon loaded silicone.

4. The article according to claim 1, wherein the layers of polysiloxane are bonded to the fleece layer.

5. The article according to claim 1, wherein the layers of polysiloxane are each about 0.020-0.030 inches thick.

6. The article according to claim 1, further comprising a bond formed of polysiloxane materials formed at a seam of the fleece layer.

7. A second order article, comprising:
a fleece layer;
layers of polysiloxane materials applied as a skin to an interior side of the fleece layer and an exterior side of the fleece layer; and
a bond formed of polysiloxane materials formed at a seam of the fleece layer.

8. The second order article according to claim 7, wherein the fleece layer comprises a polyester fleece.

9. The second order article according to claim 7, wherein the polysiloxane materials comprise carbon loaded silicone.

10. The second order article according to claim 7, wherein the layers of polysiloxane materials are bonded to the fleece layer.

11. The second order article according to claim 7, wherein the layers of polysiloxane are each about 0.020-0.030 inches thick.

12. The second order article according to claim 7, wherein the fleece layer and the layers of polysiloxane materials form:
a turtleneck portion configured to be sealably coupled to a tool,
a head portion defining sealed apertures through which tool elements are extendable, and
a cape portion supportively interposed between the turtleneck portion and the head portion,
the bond being formed as a plurality of bonds at respective interfaces between the cape portion and the turtleneck and head portions.

13. A method of forming an article, the method comprising:
screeding a polysiloxane material in paste form onto a non-stick surface to have a predefined thickness;
while the screeded polysiloxane material remains in paste form, marrying a first side of a fleece layer to the screeded polysiloxane material;
curing the polysiloxane material to form an intermediate article; and
repeating the screeding and marrying operations with respect to a second side of the fleece material to form a skinned fleece.

14. The method according to claim 13, wherein the fleece material comprises a polyester fleece.

15. The method according to claim 13, wherein the polysiloxane material comprises carbon loaded silicone.

16. The method according to claim 13, wherein the curing comprises drying the polysiloxane material.

17. The method according to claim 13, wherein the screeding comprises spreading the polysiloxane material across the non-stick surface to a thickness of about 0.020-0.030 inches.

18. The method according to claim 13, further comprising:
shaping the final article into a second order article; and
forming a bond of polysiloxane material at a seam of the fleece material.

19. The method according to claim 18, wherein the second order article is a shaped thermal sock.

20. The method according to claim 12, further comprising testing the final article at −60° C. to +100° C.
